(19) United States
(12) Patent Application Publication
(10) Pub. No.: US 2009/0158596 A1
(43) Pub. Date: Jun. 25, 2009

(54) ELECTRIC HAIR REMOVER

(75) Inventors: Kazuyuki OUCHI, Hikone (JP); Hitoshi OGAWA, Inukami-gun (JP); Wei WANG, Omihachiman (JP)

Correspondence Address: GREENBLUM & BERNSTEIN, P.L.C., 1950 ROLAND CLARKE PLACE, RESTON, VA, 20191, US

(73) Assignee: PANASONIC ELECTRIC WORKS CO., LTD., Osaka (JP)

(21) Appl. No.: 12/273,724

(22) Filed: Nov. 19, 2008

(30) Foreign Application Priority Data
Dec. 25, 2007 (JP) 2007-332613

(51) Int. Cl. B26B 19/28; B26B 19/38

(52) U.S. Cl. 30/45; 30/541

(57) ABSTRACT

An electric hair remover, includes: a body part having a head end part in a longitudinal direction, a blade part for cutting hair being formed at the head end part; a holder part mounted to the body part in such a configuration as to slide along the longitudinal direction of the body part; an operator mounted to the body part and adapted to switch an on-operation and an off-operation of a power source of the blade part; and a slide lock mechanism interlocked with the on-operation by the operator and configured to lock the sliding operation of the holder part relative to the body part.

### BACKGROUND OF THE INVENTION

1. Field of the Invention

The present invention relates to an electric hair remover (epilator) for removing hair.

2. Description of the Related Art

Conventionally, an electric hair remover such as electric razor has such a structure that a blade block for cutting hair is disposed at a head end of a body part which also serves as a holder part. A motor for driving the blade, a driver for transmitting the driving force of the motor and a battery block for driving the motor, and the like are received in the body part. Turning on (on-operation) a switch drives the motor, thereby moving the blade for removing hair.

On the other hand, Japanese Patent Application Laid-Open No. 2007-105077 (=JP2007105077) discloses a manual safety razor (referred to as “T-shaped trimmer for shaving eyebrows”) which has such a structure that a body part is made bendable or telescopic. As such, the razor has a convenient configuration during operation by the user while the razor is made compact for storage (put in a receptacle) after the operation.

### SUMMARY OF THE INVENTION

For receiving the motor, driver, battery block and the like in the body part, the above conventional electric hair remover, however, has difficulty in making the body part telescopic which also serves as a holder part. In other words, the body part of the conventional electric hair remover is fixed at a relatively short length, making it difficult to remove hair which is beyond the reach of hand or hard to reach.

It is therefore an object the present invention to provide an electric hair remover capable of improving usability during operation.

According to a first aspect of the present invention, an electric hair remover, comprises: a body part having a head end part in a longitudinal direction, a blade part for cutting hair being formed at the head end part; a holder part mounted to the body part in such a configuration as to slide along the longitudinal direction of the body part; an operator mounted to the body part and adapted to switch an on-operation and an off-operation of a power source of the blade part; and a slide lock mechanism interlocked with the on-operation by the operator and configured to lock the sliding operation of the holder part relative to the body part.

According to a second aspect of the present invention, an electric hair remover, comprises: a body part having a head end part in a longitudinal direction, a blade part for cutting hair being formed at the head end part; a holder part mounted to the body part in such a configuration as to slide along the longitudinal direction of the body part and to rotate; an operator mounted to the body part and adapted to switch an on-operation and an off-operation of a power source of the blade part; a slide lock mechanism interlocked with the operator and configured to lock the sliding operation of the holder part relative to the body part; and a rotation lock mechanism interlocked with the operator and configured to lock the rotating operation of the holder part relative to the body part.

Other objects and features of the present invention will become understood from the following description with reference to the accompanying drawings.

### BRIEF DESCRIPTION OF THE DRAWINGS

FIG. 1 is a front view of an electric hair remover, according to an embodiment of the present invention.

FIG. 2 is a side view of the electric hair remover, according to the embodiment of the present invention.

FIG. 3 is a cross sectional view taken along the line III-III in FIG. 1.

FIG. 4 is a front view of the electric hair remover, with a holder part and a front cover removed, according to the embodiment of the present invention.

FIG. 5 is a side view of the electric hair remover, with the holder part and front cover removed, according to the embodiment of the present invention.

FIG. 6 is a front view of the electric hair remover, with the holder part most pulled out, according to the embodiment of the present invention.

FIG. 7 is a side view of the electric hair remover, with the holder part most 10 pulled out, according to the embodiment of the present invention.

FIG. 8 is a cross sectional view taken along the line VIII-VIII in FIG. 7.

FIG. 9 is a front view of the holder part of the electric hair remover, according to the embodiment of the present invention.

FIG. 10 is a cross sectional view taken along the line X-X in FIG. 9.

FIG. 11 is a cross sectional view of an angle adjuster of the electric hair remover, according to the embodiment of the present invention.

FIG. 12 is a perspective view of the electric hair remover, with the holder part most rotated, according to the embodiment of the present invention.

FIG. 13 is a side view of the electric hair remover, with the holder part most rotated, according to the embodiment of the present invention.

FIG. 14 is a side view showing that a load relief part of the electric hair remover is in operation, according to the embodiment of the present invention.

FIG. 15 is a side view of an angle adjuster when the load relief part of the electric hair remover is in operation, according to the embodiment of the present invention.

FIG. 16 is a cross sectional view taken along the line XVI-XVI in FIG. 4.

FIG. 17 is a front view of the electric hair remover, with the front cover and a switch connector plate removed, according to the embodiment of the present invention.

### DESCRIPTION OF THE PREFERRED EMBODIMENTS

In the following, various embodiments of the present invention will be described in detail with reference to the accompanying drawings.

For ease of understanding, the following description will contain various directional terms, such as right, left, upper, lower, forward, rearward and the like. However, such terms are to be understood with respect to only a drawing or drawings on which the corresponding part of element is illustrated.

In addition, it is noted that the drawings referred to hereinafter as illustrating the preferred embodiment of the present invention are not to scale and are schematic in nature and, therefore, should not be taken too literally. Nevertheless, the drawings illustrate the invention sufficiently to enable one skilled in the art to practice the invention.

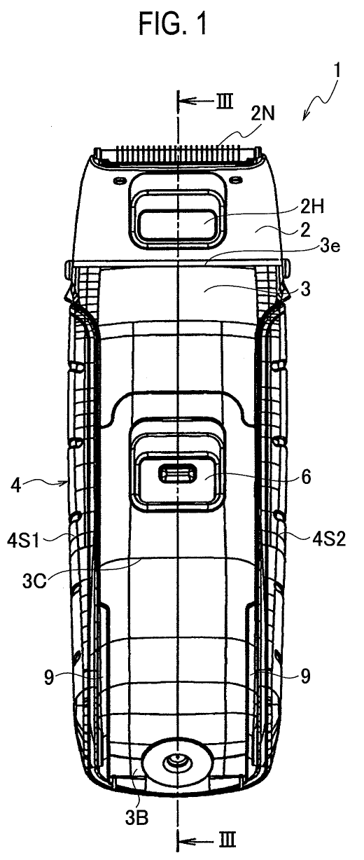

FIG. 1 to FIG. 17 show an electric hair remover, according to an embodiment of the present invention.

FIG. 1 is a front view of the electric hair remover.

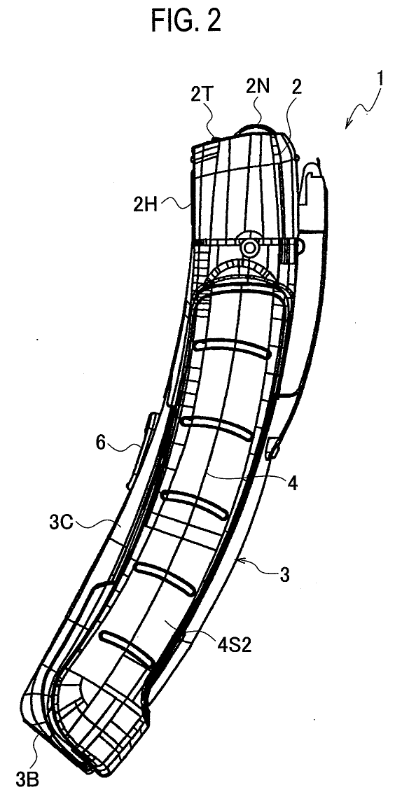

FIG. 2 is a side view of the electric hair remover.

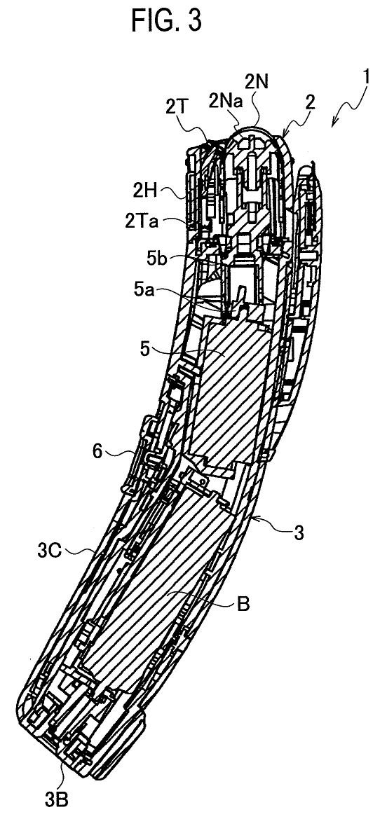

FIG. 3 is a cross sectional view taken along the line III-III in FIG. 1.

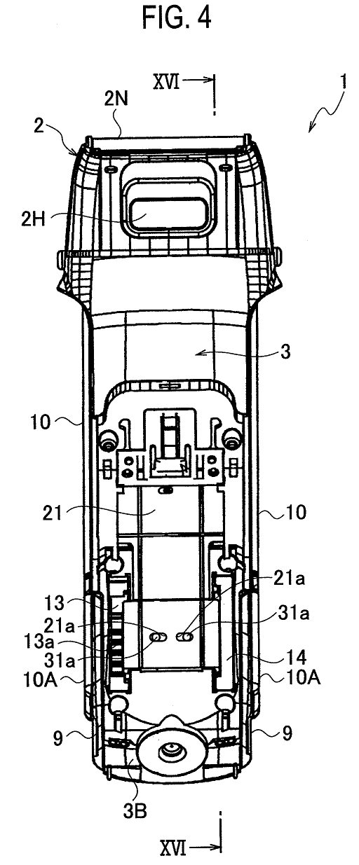

FIG. 4 is a front view of the electric hair remover, with a holder part and a front cover removed.

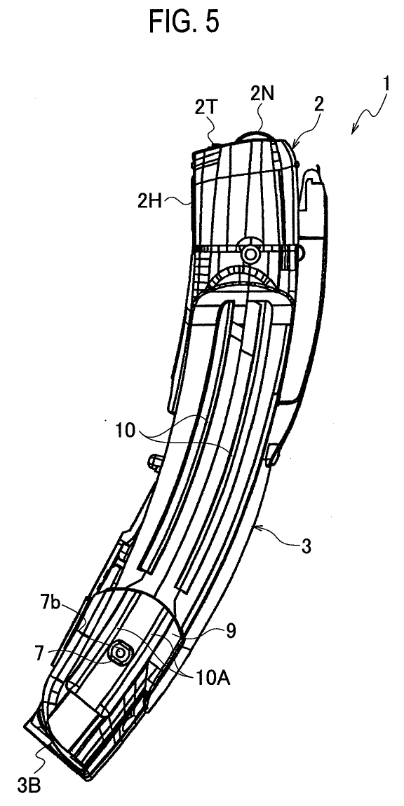

FIG. 5 is a side view of the electric hair remover, with the holder part and front cover removed.

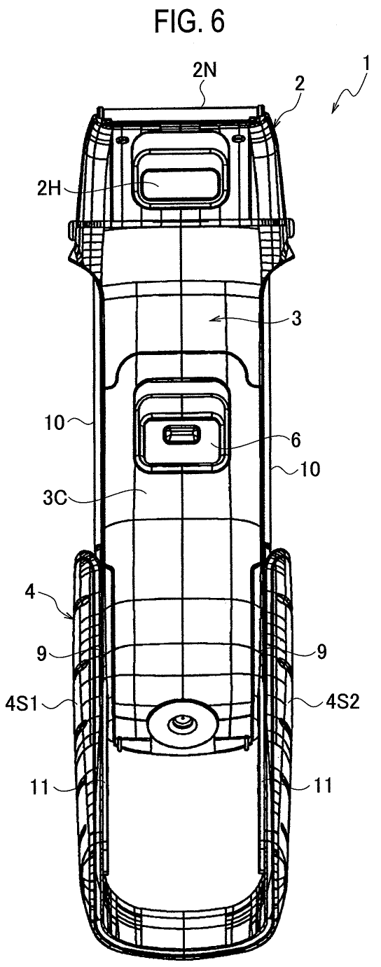

FIG. 6 is a front view of the electric hair remover, with the holder part most pulled out.

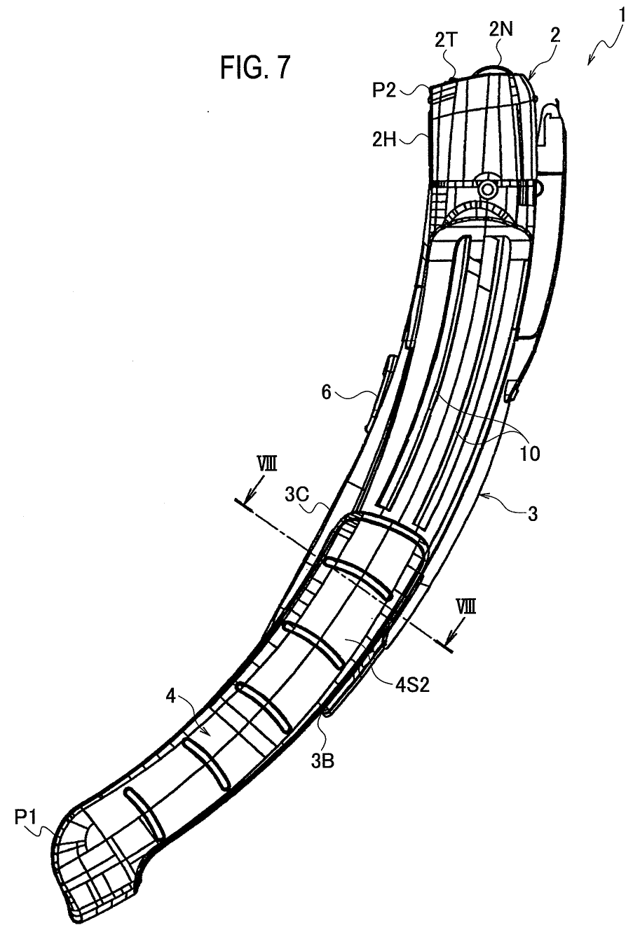

FIG. 7 is a side view of the electric hair remover, with the holder part most pulled out.

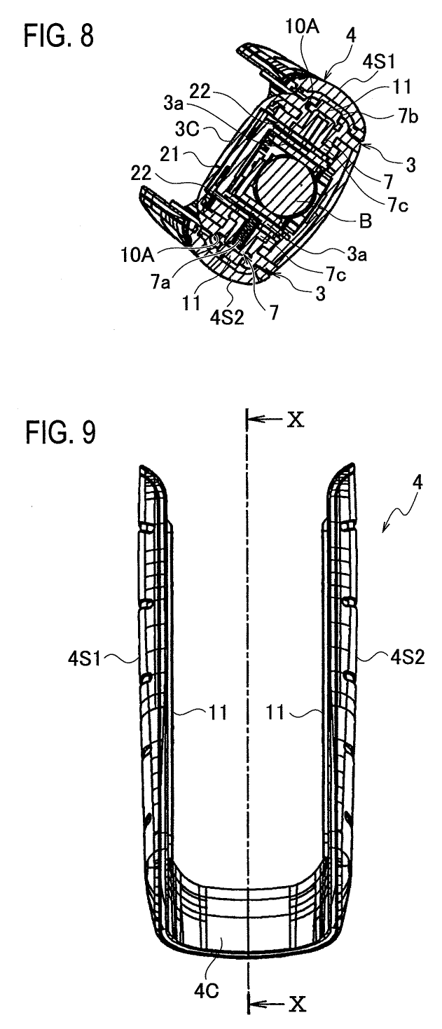

FIG. 8 is a cross sectional view taken along the line VIII-VIII in FIG. 7.

FIG. 9 is a front view of the holder part of the electric hair remover.

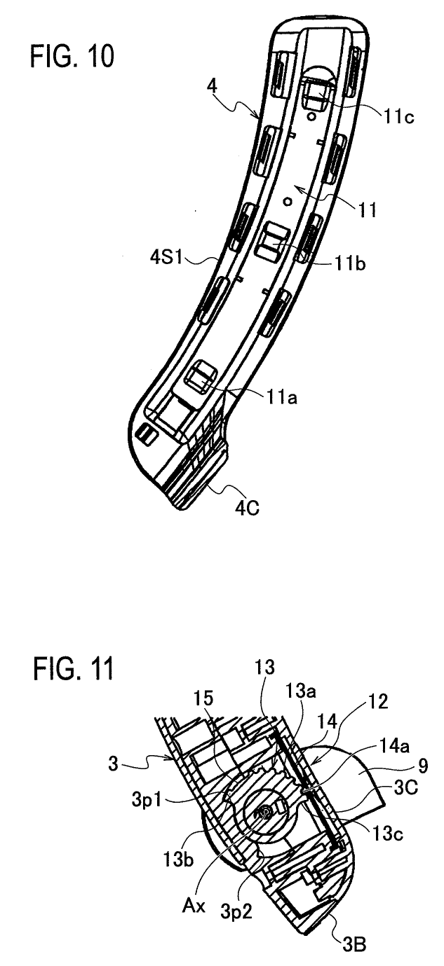

FIG. 10 is a cross sectional view taken along the line X-X in FIG. 9.

FIG. 11 is a cross sectional view of an angle adjuster of the electric hair remover.

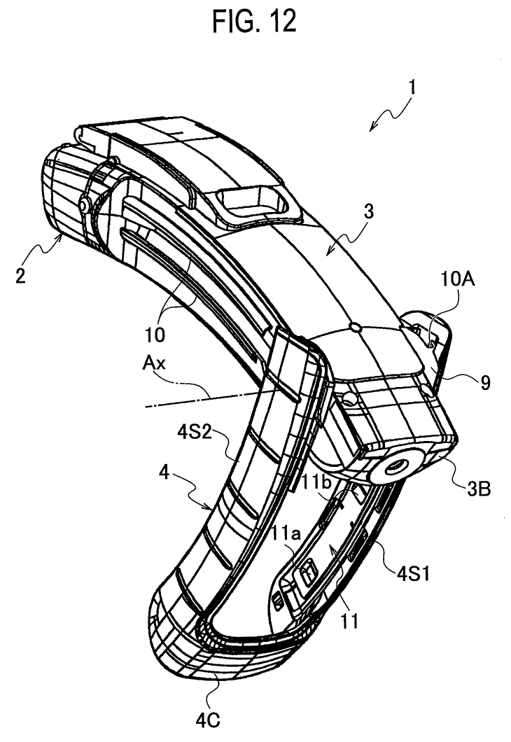

FIG. 12 is a perspective view of the electric hair remover, with the holder part most rotated.

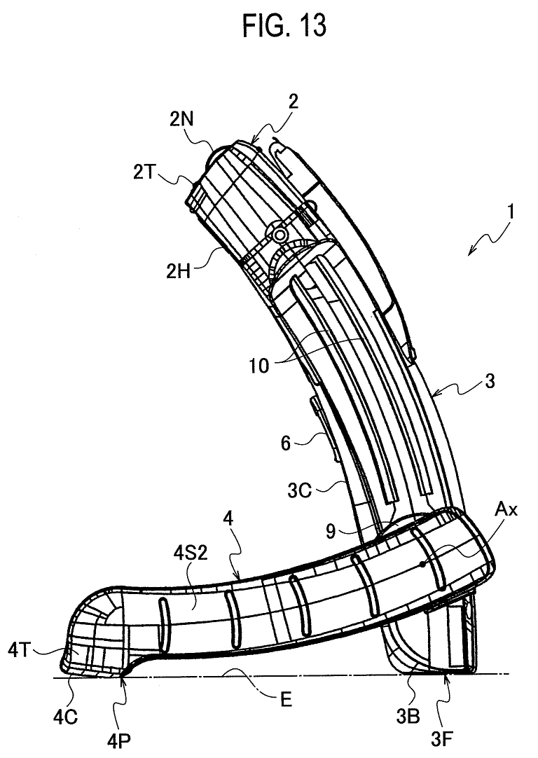

FIG. 13 is a side view of the electric hair remover, with the holder part most rotated.

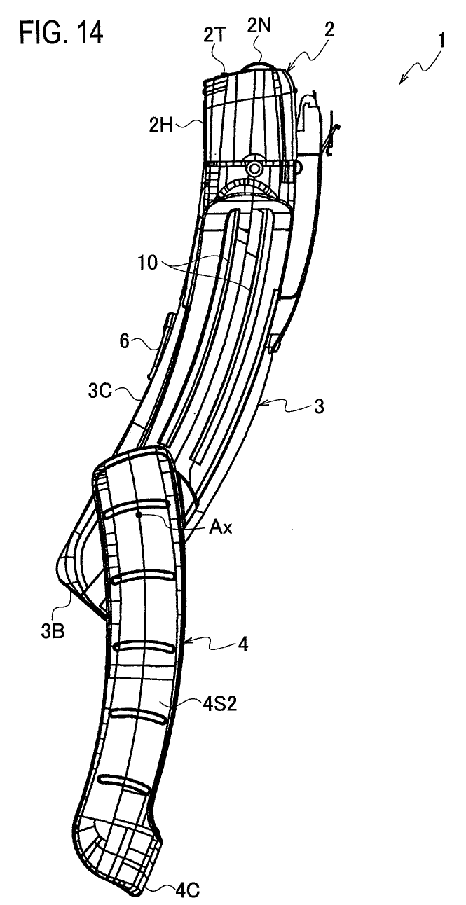

FIG. 14 is a side view showing that a load relief part of the electric hair remover is in operation.

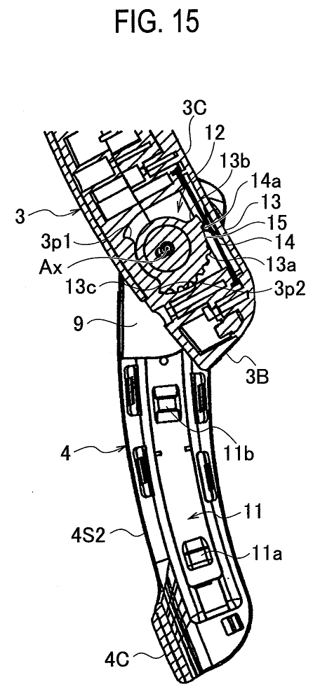

FIG. 15 is a side view of an angle adjuster when the load relief part of the electric hair remover is in operation.

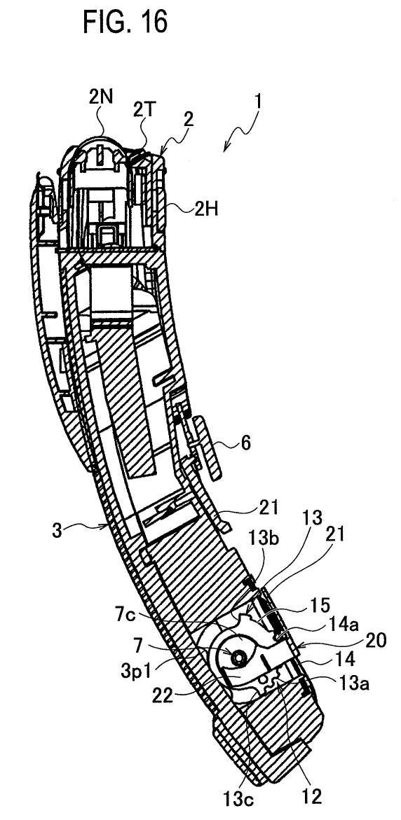

FIG. 16 is a cross sectional view taken along the line XVI-XVI in FIG. 4.

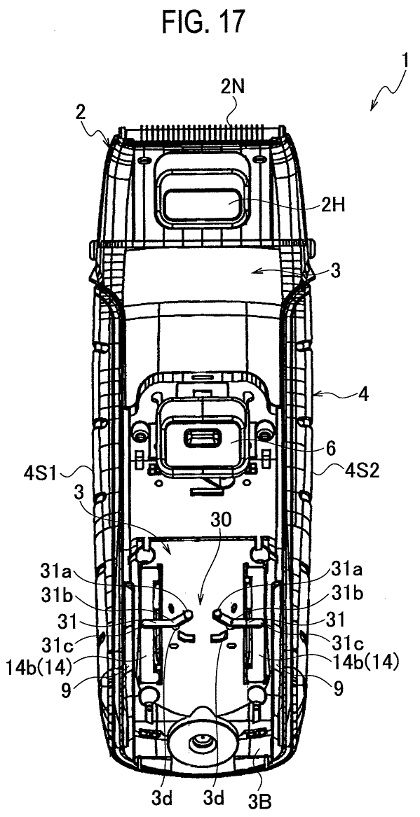

FIG. 17 is a front view of the electric hair remover, with the front cover and a switch connector plate removed.

As shown in FIG. 1 and FIG. 2, an electric hair remover 1 (epilator) according to an embodiment includes a body part 3 having such a structure that a blade block 2 as a blade part for cutting hair is disposed at a head end 3e along a longitudinal direction (upper-lower direction in FIG. 1 and FIG. 2).

In the longitudinal direction, the body part 3 is gently curved along an arc having substantially a constant radius, as shown in FIG. 2. According to the curved configuration of the body part 3, portions of a holder part 4 on respective right and left sides of the body part 3 are each curved. Hereinafter, for convenience' sake, a radial inner side of the curved body part 3 is defined as front side while a radial outer side of the body part 3 is defined as back side.

The blade block 2 has a comb-shaped trimmer blade 2T for cutting a long hair and a net blade 2N for finishing the hair shortened by the trimmer blade 2T. The net blade 2N fixedly protrudes at a head end of the blade block 2. Meanwhile, upward-downward operations of a trimmer handle 2H disposed on the front side of the blade block 2 allow the trimmer blade 2T to protrude (upward) from and subside (downward) in the head end of the blade block 2.

As shown in FIG. 3, the body part 3 includes a motor 5 for driving the trimmer blade 2T and net blade 2N. To a head end of the motor 5, a driver 5b is mounted via an eccentric cam 5a in such a state that the driver 5b is eccentric. It is so structured that rotation of the motor 5 is converted into reciprocation of the driver 5b. Moreover, the body part 3 includes a battery block B for driving the motor 5.

Moreover, an inner blade 2Na of the net blade 2N is mounted to a head end of the driver 5b, and it is so configured that the inner blade 2Na sliding with the net blade 2N cuts hair. Furthermore, a trimmer driver 2Ta for transmitting the driving force to the trimmer blade 2T is disposed on the way of the driver 5b.

A switch handle 6 as an operator is disposed substantially in the center on the front side of the body part 3. Being hooked with a hook (not shown) of a front cover 3C of the body part 3, the switch handle 6 makes reciprocation in the longitudinal direction, thereby switching open-and-close of a circuit for driving the motor 5. As such, the switch handle 6 serves as an operator for switching ons-and-offs (i.e., on-operation and off-operation) of a power source.

In addition, the electric hair remover 1 according to the embodiment has the holder part 4 which is a member separated from the body part 3. The holder part 4 is mounted to the body part 3 in such a configuration as to be telescopically slidable relative to the body part 3 along the longitudinal direction and to make a rotation relative to the body part 3.

As shown in FIG. 9, the holder part 4 includes a left part 4S1, a right part 4S2 and a connector part 4C which are combined to be shaped substantially into an alphabetical U extending along an outer periphery of the body part 3. Hereinabove, the left part 4S1 and right part 4S2 extend on respective left and right sides in the lateral direction of the body part 3 in front view while the connector part 4C connects head end sides (in the pull-out direction) of the respective left and right parts 4S1, 4S2.

As shown in FIG. 4 and FIG. 5, rotation bases 9 each configured to make a rotation around a slide lock button 7 are disposed on both sides of a base part 3B in the lower part of the body part 3.

Moreover, on a sideface of the body part 3, a rail groove 10 is formed for allowing the holder part 4 to slide on the rail groove 10. Meanwhile, the rotation base 9 has a rail groove 10A on an extension of the rail groove 10.

Meanwhile, as shown in FIG. 10, a rail 11 slidably engaged with the rail grooves 10, 10A is formed on an inner face of each of the left and right parts 4S1, 4S2 of the holder part 4, where FIG. 10 shows the left part 4S1.

Inserting the rails 11 into the rail grooves 10, 10A allows the portions of the holder parts 4 to be disposed on both sides of the body part 3, as shown in FIG. 1 and FIG. 2. Then, sliding the rails 11 along the rail grooves 10, 10A allows the holder part 4 to move along the longitudinal direction of the body part 3.

The above accomplishes a structure which allows a combination of the body part 3 and holder part 4 to make a telescopic movement. Hereinabove and hereinafter, FIG. 1 and FIG. 2 show a shrunk state of the combination while FIG. 6 and FIG. 7 show an extended state of the combination.

In addition, as shown in FIG. 10, on the inner side of the rail 11, a plurality of rail dent parts 11a, 11b, 11c each disengageably mated with the slide lock button 7 are disposed at certain intervals in the longitudinal direction.

As shown in FIG. 8, an inner face of the slide lock button 7 is formed with a coil spring 7a which is so set as to continuously press (bias) the slide lock button 7 outward.

As such, a head end of the slide lock button 7 is caused to continuously protrude through a hole formed in the rail groove 10A disposed on the rotation base 9.

Then, a head end protrusion part 7b of the slide lock button 7 is so configured to be sequentially mated with the rail dent parts 11a, 11b, 11c according to sliding positions of the holder part 4.

In other words, with the body part 3 and holder part 4 most shrunk, the head end protrusion part 7b of the slide lock button 7 is brought into such a state as to be mated with the rail dent part 11a. In this state, pulling the holder part 4 in the extended direction disengages the head end protrusion part 7b from the rail dent part 11a, thus allowing the holder part 4 to slide with the head end protrusion part 7b pressed in.

Then, when the next rail dent part 11b comes to a position of the slide lock button 7 according to the sliding of the holder part 4, the biasing force of the coil spring 7a allows the head end protrusion part 7b of the slide lock button 7 to protrude and thereby to engage with the rail dent part 11b, thus fixing the holder part 4. Likewise, with the holder part 4 most pulled out of the body part 3, the head end protrusion part 7b of the slide lock button 7 is mated with the rail dent part 11 c, thus fixing the holder part 4.

The rail 11 is mated with both of the rail groove 10 on the body part 3 side and the rail groove 10A on the rotation base 9 side. As shown in FIG. 6 and FIG. 7, however, with the body part 3 and holder part 4 most extended (i.e., the holder part 4 most pulled out of the body part 3), that is, when the slide lock button 7 is engaged with the rail dent part 11c, the rail 11 is removed from the rail groove 10 and mates only with the rail groove 10A.

As such, the rotation base 9 is allowed to make a rotation only when the body part 3 and holder part 4 are most extended. In this state, as shown in FIG. 12 and FIG. 13, the body part 3 can be so bent relative to the holder part 4 as to form substantially an alphabetical V in combination with the holder part 4. A rotation center brought about in this state is referred to as a rotation axis Ax in FIG. 12 and FIG. 13.

Then, as shown in FIG. 11, the rotation base 9 as a rotation part of the holder part 4 has an angle adjuster 12 for accomplishing multi-step rotational fixations within the rational area of the holder part 4. The angle adjuster 12 includes a click gear 13 and a plate-spring click plate 14, where the click gear 13 is integrally rotatable with the rotation base 9 and has an outer periphery formed with a gear-shaped irregular part 13a while the click plate 14 is disposed on the body part 3 side and adds a rotational resistance to the irregular part 13a of the click gear 13.

A protrusion part 14a engageable with a dent of the irregular part 13a of the click gear 13 is formed in substantially the center part of the click plate 14. The protrusion part 14a engaged with one of the dents of the irregular part 13a can prevent the rotation of the rotation base 9 by means of a certain resistance force.

Then, applying to the rotation base 9 a rotational force having a certain resistance force or over allows the protrusion part 14a of the click plate 14 to be pushed out of the dent of the irregular part 13a while allowing the rotation of the click gear 13, thus varying the rotation angle (i.e., angle between the body part 3 and the holder part 4) of the holder part 4.

The irregular part 13a is formed corresponding to the allowable rotational area of the holder part 4. First and second stepped parts 13b, 13c formed on respective sides of the irregular part 13a of the click gear 13 are configured to abut on respective first and second stopper parts 3p1, 3p2 formed on the body part 3 side, thus stopping the rotation of the holder part 4 to thereby prevent further rotation of the holder part 4.

Moreover according to the embodiment, the body part 3 is gently curved in the longitudinal direction. As shown in FIG. 11, the angle adjuster 12 of the rotation base 9 has a load relief part 15. The load relief part 15 is so set as to make the following operation:

When the holder part 4 slides in the longitudinal direction of the body part 3 thereby forming an extended state in a curved form in combination with the body part 3, the load relief part 15 relieves, corresponding to a certain load or over applied to the rotation base 9, the body part 3 from the holder part 4 in the direction for opening (see FIG. 14).

In other words, the load relief part 15 is, as shown in FIG. 11, set by cutting away the irregular part 13a of the click gear 13 in a certain range. That is, in the following range, the load relief part 15 is formed by cutting away the irregular part 13a which corresponds to the protrusion part 14a of the click plate 14:

From a first state that the holder part 4 is extended (see FIG. 7) to a second state that the holder part 4 is rotated in the opening direction (see FIG. 14).

The above structure accomplishes the following operation:

After the protrusion part 14a of the click plate 14 goes over the protrusion of the irregular part 13a (which has the dent engageable with the protrusion part 14a) with the holder part 4 ordinarily extended, the holder part 4 is made free. Then, as shown in FIG. 15, the holder part 4 is allowed to be bent without resistance until the second stepped part 13c of the click gear 13 abuts on the second body part 3p2.

When the body part 3 and holder part 4 are most extended to form substantially an arch, i.e., when the electric hair remover 1 is disposed on a flat face (such as upper face of a shelf) as a pedestal such that the left side (in FIG. 7) of the electric hair remover 1 is disposed downward, a sudden load which may be applied leftward in FIG. 7 to the center part of the arch is entirely received by a first head end P1 of the holder part 4 and a second head end P2 of the blade block 2.

According to the embodiment, the load relief part 15 provided for the rotation base 9 works to allow the body part 3 and holder part 4 to open in a form of a reversed bending, as shown in FIG. 14. As such, an edge part of the base part 3B of the body part 3 contacts the flat base and thereby can receive the load.

Moreover according to the embodiment, as shown in FIG. 13, a substantially flat mounting face 3F is formed on a surface of the base part 3B. In the longitudinal direction, the base part 3B is disposed on a side opposite to a side of the head end part 3e (for providing the blade block 2) of the body part 3.

With the holder part 4 rotated, a single point of a part (the head end part 4T according to the embodiment) spaced apart from the rotation axis Ax of the holder part 4 is disposed on an extended face E along the mounting face 3F. The single point is defined as a contact part 4P.

In addition, according to the embodiment, with the body part 3 and holder part 4 most rotated, the head end part 4T of the holder part 4 is disposed on the extended face E of the mounting face 3F.

With this, for such a case as to remove unwanted hair on the back and the like with the electric hair remover 1, the electric hair remover 1 can be disposed in such a state that the holder part 4 is most rotated for use while the body part 3 is standing on the flat face as the pedestal.

Herein, as shown in FIG. 9, the holder part 4 having the left and right parts 4S1, 4S2 and the connector part 4C is formed substantially into an alphabetical U. With the above configuration, pulling the holder part 4 out of the body part 3 allows the thus pulled-out part of the holder part 4 to be kept hooked with a hook and the like (not shown).

In a shower room and the like, the user, as the case may be, removes hair in a standing state. In such a case, for checking the finished state after clearing (or dusting) off the hair which was adhered to the body, the user is supposed to once release the electric hair remover 1 from hand. In this case, hooking the pulled-out holder part 4 (set forth above) with a protrusion such as hook can rapidly restart the hair-removing operation without leaving the electric hair remover 1 on the floor or the like.

### <Slide Lock Mechanism 20>

Herein, according to the embodiment, the electric hair remover 10 has a slide lock mechanism 20. Being interlocked with on-operations of the switch handle 6 as an operator, the slide lock mechanism 20 locks the holder part 4's sliding movement relative to the body part 3, as shown in FIG. 16.

The slide lock mechanism 20 includes the slide lock button 7, an after-described switch connector plate 21 as a switch connector member and a slide regulator piece 22 interlocked with the switch connector plate 21.

As set forth above, the biasing force of the coil spring 7a shown in FIG. 8 works to allow the slide lock button 7 to be disengageably mated with a plurality of rail dent parts 11a, 11b, 11c which are disposed at certain intervals in the longitudinal direction at the left and right parts 4S1, 4S2 of the holder part 4 (see FIG. 10).

As shown in FIG. 4 in combination with FIG. 16, the switch connector plate 21 disposed on an inner side of the body part 3 is engaged with the switch handle 6. Being interlocked with the on-and-off operations (respectively upper and lower movements in FIG. 4) of the switch handle 6, the switch connector plate 21 makes a reciprocation in the longitudinal direction.

As shown in FIG. 16, the slide regulator pieces 22 on left and right sides in plan view protrude to inward of the body part 3 from left and right sides (in plan view) of the switch connector plate 21's position corresponding to the slide lock button 7. The slide regulator pieces 22 are each removably inserted between the base wall part 7c of the slide lock button 7 and the sidewall part 3a of the body part 3 (See FIG. 8).

In addition, when the switch connector plate 21 moves toward the first side in the longitudinal direction (upward in FIG. 1 and FIG. 4) according to the on-operation of the switch handle 6, the slide regulator piece 22 enters between the base wall part 7c of the slide lock bottom 7 and the sidewall part 3a of the body part 3 (See FIG. 8), thus preventing the slide lock button 7 from entering the body part 3.

As such, in a state that the slide lock button 7 proceeds from the body part 3 toward outside and then is inserted into any one of the rail dent parts 11a, 11b, 11c of the holder part 4, the slide lock button 7 is locked by means of the slide regulator piece 22. As such, the holder part 4 is unable to slide relative to the body part 3.

Meanwhile, when the switch connector plate 21 moves oppositely toward the second side in the longitudinal direction (downward FIG. 1 and FIG. 4) according to the off-operation of the switch handle 6, the slide regulator piece 22 exits from between the base wall part 7c and the sidewall part 3a (See FIG. 8).

As such, in this state, regulation of the slide lock button 7's movement (protrusion and subsidence) by the slide regulator piece 22 is released, thus allowing the holder part 4 to slide relative to the body part 3.

Otherwise, the switch connector plate 21 and the slide regulator piece 22 may be integrated.

### <Rotation Lock Mechanism 30>

Moreover according to the embodiment, a rotation lock mechanism 30 is provided for the rotation part of the holder part 4, as shown in FIG. 17. Being interlocked with the on-operation of the switch handle 6, the rotation lock mechanism 30 locks the holder part 4's rotation relative to the body part 3.

The rotation lock mechanism 30 includes the above-described click gear 13 as a click member, the above-described click plate 14 as a plate spring member, the above-described switch connector plate 21 as a switch connector member and an after-described rotation regulator piece 31 which is interlocked with the switch connector plate 21.

As shown in FIG. 11, the click gear 13 is integrally rotatable with the rotation base 9 and has the outer periphery formed with the irregular part 13a in a form of gear. The protrusion part 14a of the click plate 14 is elastically engageable with the dent of the irregular part 13a by means of a biasing force (elastic force).

As shown in FIG. 4, the switch connector plate 21 is formed with hole parts 21a. A head end protrusion part 31a at a first end of the rotation regulator piece 31 in FIG. 17 is mated with the hole part 21a.

Moreover, a central protrusion part 31b (see FIG. 17) is disposed substantially in the center of the rotation regulator piece 31. The central protrusion part 31b is rotatably mated with a hole 3d formed in the backface of the front cover 3C, such that the rotation regulator piece 31 is rotatable around the central protrusion part 31b.

Then, according to the rotation of the rotation regulator piece 31, another end part 31c of the rotation regulator piece 31 moves toward or away relative to a position where the other end part 31c is superposed with an outer face 14b (near side in FIG. 17) of the click plate 14.

As such, when the switch connector plate 21 moves toward the first side in the longitudinal direction (upward in FIG. 1 and FIG. 4) according to the on-operation of the switch handle 6, the rotation regulator piece 31 interlocked with the switch connector plate 21 makes a rotation, with the other end part 31c moved to the position where the other end part 31c is superposed with the outer face 14b of the click plate 14, as shown in FIG. 17.

As such, the other end part 31c prevents deformation of the click plate 14, thus engaging the protrusion part 14a of the click plate 14 with any one of the dents of the irregular part 13a of the click gear 13, to thereby lock the protrusion part 14a. As such, the rotation base 9, that is, the holder part 4 is unable to rotate relative to the body part 3.

Meanwhile, when the switch connector plate 21 moves toward the second side in the longitudinal direction (downward in FIG. 1 and FIG. 4) according to the off-operation of the switch handle 6, the rotation regulator piece 31 makes an opposite rotation around the central protrusion part 31b, with the other end part 31c removed from the position where the other end part 31c is superposed with the outer face 14b of the click plate 14.

According to the embodiment, the other end part 31c moves upward and toward the center in the lateral direction, when viewed in FIG. 17.

As such, in this state, the click plate 14's regulation by the other end part 31c is released, thereby allowing the holder part 4 to rotate relative to the body part 3.

Herein, a gap between the outer face 14b (of the click plate 14) and the front cover 3C is substantially equal to the thickness of the other end part 31c of the rotation regulator piece 31 or slightly larger than the same. When the other end part 31c of the rotation regulator piece 31 is superposed with the outer face 14b of the click plate 14, the other end part 31c can be pressed by means of the front cover 3C, thus more securely preventing deformation of the click plate 14.

As set forth above, according to the embodiment, the holder part 4 which is a member separated from the body part 3 is telescopically slidable relative to the body part 3 in the longitudinal direction and rotatable relative to the body part 3.

As such, when the user abuts the blade block 2 on skin, length or angle of the body part 3 in combination with the holder part 4 can be conveniently changed, thus improving usability of the electric hair remover 1.

As such, the blade block 2 at the head end of the electric hair remover 1 of the present invention can easily abut on tiptoes, calf, back and the like on which the conventional fixed-type counterpart fails to easily abut. Especially, rotating the holder part 4 in its elongated state allows the blade block 2 to abut on a portion far away from hand, such as back.

Moreover, being interlocked with the on-operation of the switch handle 6 as an operator, the slide lock mechanism 20 works for locking the sliding of the holder part 4 relative to the body part 3. As such, a sudden sliding of the holder part 4 relative to the body part 3 which sliding may be caused when the user is using the electric hair remover 1 can be prevented, thus more improving usability of the electric hair remover 1.

Moreover according to the embodiment, the slide lock mechanism 20 includes the slide lock button 7, the switch connector plate 21 and the slide regulator piece 22. By means of a biasing force, the slide lock button 7 is disengageably mated with the plural rail dent parts 11a, 11b, 11c which are disposed on the holder part 4 at certain intervals in the longitudinal direction. Being interlocked with the switch handle 6, the switch connector plate 21 makes a reciprocation. The slide regulator piece 22 works to prevent the slide lock button 7 from being released from the rail dent parts 11a, 11b, 11c in the on-operation of the switch handle 6.

As such, the slide lock mechanism 20 can have a relatively simple structure.

Moreover according to the embodiment, being interlocked with the switch handle 6, the rotation lock mechanism 30 locks rotation of the holder part 4 relative to the body part 3.

As such, a sudden rotation of the holder part 4 relative to the body part 3 which rotation may be caused when the user is operating the electric hair remover 1 can be prevented, thus further improving usability of the electric hair remover 1.

Moreover according to the embodiment, the rotation lock mechanism 30 includes the click gear 13, the click plate 14, the switch connector plate 21 and the rotation regulator piece 31.

The click gear 13 is integrally rotatable with the holder part 4 and has the outer periphery formed with the irregular part 13a.

By means of a biasing force, the click plate 14 is disengageably mated with the irregular part 13a of the click gear 13.

Being interlocked with the switch connector plate 21, the rotation regulator piece 31 works for preventing the click plate 14 from being released from the click gear 13 in the on-operation of the switch handle 6.

As such, the rotation lock mechanism 30 can have a simple structure.

Although the embodiment of the present invention has been described above, the present invention is not limited to the above embodiment. Modifications and variations of the embodiment described above will occur to those skilled in the art, in light of the above teachings.

For example, detailed structure of each of the slide lock mechanism 20 and the rotation lock mechanism 30 may be varied.

Moreover, configuration, position and the like of each of the mounting face 3F and the contact part 4P may be properly changed.

Furthermore, the trimmer blade 2T and net blade 2N are disposed at the blade block 2, but not limited thereto. A single blade or other blade(s) may be provided for the blade block 2.

This application is based on a prior Japanese Patent Application No. P2007-332613 (filed Dec. 25, 2007 in Japan). The entire contents of the Japanese Patent Application No. P2007-332613 from which priority is claimed are incorporated herein by reference, in order to take some protection against translation errors or omitted portions.

The scope of the present invention is defined with reference to the following claims.

What is claimed is:

1. An electric hair remover, comprising:
a body part having a head end part in a longitudinal direction, a blade part for cutting hair being formed at the head end part;
a holder part mounted to the body part in such a configuration as to slide along the longitudinal direction of the body part;
an operator mounted to the body part and adapted to switch an on-operation and an off-operation of a power source of the blade part; and
a slide lock mechanism interlocked with the on-operation by the operator and configured to lock the sliding operation of the holder part relative to the body part.

2. The electric hair remover according to claim 1, wherein
the slide lock mechanism includes:
a slide lock button disengageably mated with a plurality of dent parts by a biasing force of a biasing member, the dent parts being disposed at the holder part at certain intervals in the longitudinal direction,
a switch connector member interlocked with the operator and configured to make a reciprocation, and
a slide regulator piece interlocked or integrated with the switch connector member and configured to prevent the slide lock button from being released from the dent parts when the operator is making the on-operation.

3. An electric hair remover, comprising:
a body part having a head end part in a longitudinal direction, a blade part for cutting hair being formed at the head end part;
a holder part mounted to the body part in such a configuration as to slide along the longitudinal direction of the body part and to rotate;
an operator mounted to the body part and adapted to switch an on-operation and an off-operation of a power source of the blade part;
a slide lock mechanism interlocked with the operator and configured to lock the sliding operation of the holder part relative to the body part; and
a rotation lock mechanism interlocked with the operator and configured to lock the rotating operation of the holder part relative to the body part.

4. The electric hair remover according to claim 3, wherein
the rotation lock mechanism includes:
a click member integrally rotatable with the holder part and having an outer periphery formed with an irregular part,
a rotation lock member disengageably mated with the irregular part of the click member by a biasing force,
a switch connector member interlocked with the operator and configured to make a reciprocation, and
a rotation regulator piece interlocked with the switch connector member and configured to prevent the rotation lock member from being released from the click member when the operator is making the on-operation.

5. The electric hair remover according to claim 4, wherein
a rotation base as a rotation part of the holder part has an angle adjuster for accomplishing multi-step rotational fixations within a rational area of the holder part,
the angle adjuster includes the click member and the rotation lock member, where the click member is integrally rotatable with the rotation base while the rotation lock member is disposed on the body part side and adds a rotational resistance to the irregular part of the click member, and
a protrusion part engageable with a dent of the irregular part of the click member is formed in substantially a center part of the rotation lock member.

6. The electric hair remover according to claim 5, wherein
the irregular part is formed corresponding to an allowable rotational area of the holder part, and
first and second stepped parts formed on respective sides of the irregular part of the click member are configured to abut on respective first and second stopper parts formed on the body part side.

7. The electric hair remover according to claim 6, wherein
the body part is gently curved in the longitudinal direction,
the angle adjuster of the rotation base has a load relief part, and
the load relief part is so configured as to make the following operation:
when the holder part slides in the longitudinal direction of the body part thereby forming an extended state in a curved form in combination with the body part, the load relief part relieves, corresponding to a certain load or over applied to the rotation base, the body part from the holder part in the direction for opening.

8. The electric hair remover according to claim 7, wherein
in the following range, the load relief part is formed by cutting away the irregular part which corresponds to the protrusion part of the rotation lock member:
from a first state that the holder part is extended to a second state that the holder part is rotated in the opening direction.
